(19) United States
(12) Patent Application Publication
(10) Pub. No.: US 2026/0124883 A1
(43) Pub. Date: May 7, 2026

(54) ELECTRIC DRIVE AIR CONDITIONER

(71) Applicant: Rodolfo Favela, Las Vegas, NV (US)

(72) Inventor: Rodolfo Favela, Las Vegas, NV (US)

(21) Appl. No.: 19/378,816

(22) Filed: Nov. 4, 2025

Related U.S. Application Data
(60) Provisional application No. 63/833,207, filed on Nov. 5, 2024.

(51) Int. Cl. B60H 1/32

(52) U.S. Cl. CPC B60H 1/3222

(57) ABSTRACT

An electric fan air conditioning system kit to enable efficient and reliable air conditioning independent of engine operation, thereby improving energy efficiency and overall driver comfort. The aftermarket electric motor kit is designed to be installed in a vehicle to enable the intrinsic air conditioner without starting or utilizing the vehicular engine, eliminating the parasitic engine load of the prior art that handcuffs current vehicular air conditioning systems.

### CROSS REFERENCE TO RELATED APPLICATION

This application claims the benefit of priority of U.S. provisional application No. 63/833,207, filed Nov. 5, 2024, the contents of which are herein incorporated by reference.

### BACKGROUND OF THE SUBJECT DISCLOSURE

The present subject disclosure relates to vehicular air conditioning systems and, more particularly, to an electric fan air conditioning system kit.

An air conditioning (“A/C”) compressor is a crucial component of the vehicles air conditioning systems. The compressor pressurizes the refrigerant gas, raising its temperature and pressure before sending it to the condenser, which in turn keeps the ambient air inside the vehicle cooler than the outside ambient air. The automotive compressor is usually belt-driven by the engine's crankshaft. Commonly, automotive compressors are of the swash plate type, rotary type, or reciprocating piston type. Inside the compressor, pistons or vanes compress the refrigerant gas. It also typically includes a clutch mechanism that engages/disengages the compressor as needed. Automotive compressors may be mounted on the engine block, connected via a drive belt.

Mechanical A/C compressors, though, have key disadvantages, including but not limited to imposing a significant engine load and, as a result, lowering fuel efficiency. Specifically, vehicular A/C compressors are belt-driven off the engine, thereby adding a parasitic load, and thereby reducing fuel efficiency, especially noticeable when the A/C is running continuously.

Another related disadvantage is that vehicular A/C compressor's cooling performance is dependent on engine speed, as the engine in turn drives the compressor belts. At low engine RPMs (idling or slow speeds), the compressor output drops, causing less effective cooling.

Another drawback of current vehicular A/C compressors is the wear and maintenance. Specifically, mechanical parts like belts, pulleys, and clutches of the vehicular A/C compressors wear out and require periodic maintenance or replacement.

Yet another downside is that when the engine is off or running intermittently, the mechanical compressor cannot operate effectively, limiting A/C functionality. In other words, in many automotive settings, mechanical compressors waste engine power and perform poorly at low RPMs.

Many drivers, for the foregoing reasons, find it inconvenient, wasteful and/or inefficient to use their vehicle's air conditioning system.

As can be seen, there is a need for an electric fan air conditioning system kit to enable efficient and reliable air conditioning that doesn't depend on engine operation, thereby improving energy efficiency and overall driver comfort.

### SUMMARY OF THE SUBJECT DISCLOSURE

In one aspect of the subject disclosure, a method of improving an air-conditioning system of a vehicle having a mechanical engagement linkage between the air-conditioning system and the engine of the vehicle, wherein the method includes the following: removing said mechanical engagement linkage; and operatively associating an electric motor to the air-conditioning system so that an intrinsic belt mechanism of the air-conditioning system, wherein the air-conditioning system comprises an intrinsic vehicular compressor unit housing the intrinsic belt mechanism and operatively associated one or more compressors, wherein the mechanical engagement linkage is a mechanical clutch, and wherein the electric motor has a pulley element to driving the intrinsic belt mechanism of the intrinsic air-conditioning system; and further fixing a housing to the electric motor and the intrinsic vehicular compressor unit.

In another aspect of the subject disclosure, a kit for improving an air-conditioning system of a vehicle having a mechanical engagement linkage between the air-conditioning system and the engine of the vehicle, wherein the kit provides the following: an electric motor; and a housing dimensioned and shaped to be connected to both the electric motor and an intrinsic vehicular compressor unit of the air-conditioning system.

These and other features, aspects and advantages of the present subject disclosure will become better understood with reference to the following drawings, description and claims.

### BRIEF DESCRIPTION OF THE DRAWINGS

FIG. 1 is a perspective view of an exemplary embodiment of the subject disclosure, illustrating an electric fan air conditioning system kit 100 with an electric motor 10 having a control unit 55 operatively associated with the intrinsic vehicular compressor unit 20 by way of an intrinsic pulley system 40 and intrinsic pulley belt system 22. The control unit 55 may embody an electrically controlled valve to operate the internal belts of compressors 30 housed in the intrinsic compressor unit 20 of the vehicular A/C system.

FIG. 2 is a perspective view of an exemplary embodiment of the subject disclosure, illustrating cover 60 of an external housing 12 for the electric motor 10 and other portions of the subject disclosure, including but not limited to the control unit 55. Cover 60 provides a seal 80 in this embodiment. The external housing 12 may be fixed to the electric motor 10 and portions of the intrinsic vehicular compressor unit 20, by way of fasteners of the like, as shown in FIG. 7.

FIG. 3 is a schematic internal view of the intrinsic vehicular compressor unit 20, illustrating an intrinsic belt mechanism 22 operatively associated with a plurality of A/C compressors 90 housed in the intrinsic vehicular compressor unit 20.

FIG. 4 is an exploded perspective view of an exemplary embodiment of the subject disclosure, illustrating the electric motor 10 location relative to vehicle 110 upon installation.

FIG. 5 is a schematic view of an exemplary embodiment of the subject disclosure, illustration installation of the kit 100 within vehicle 110.

FIG. 6 is a perspective view of an exemplary embodiment of the subject disclosure, illustrating a housing 12 having fastener holes 14.

FIG. 7 is a perspective view of an exemplary embodiment of the subject disclosure, illustrating the housing 12 connected to both the electric motor 10 and a portion of the intrinsic compressor unit 20 by way of fasteners 16, whereby the housing 12 holds the electric motor 10 to the intrinsic compressor unit 20 during post-installation operation.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the present subject disclosure provides an electric fan air conditioning system kit to enable efficient and reliable air conditioning does not depend on engine operation, thereby improving overall energy efficiency and overall driver comfort when the engine is not on as the kit's electric motor/fan is independent of the engine's operative state.

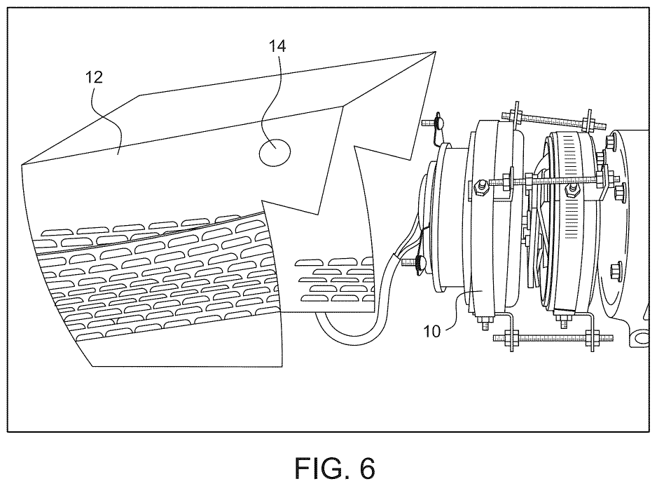

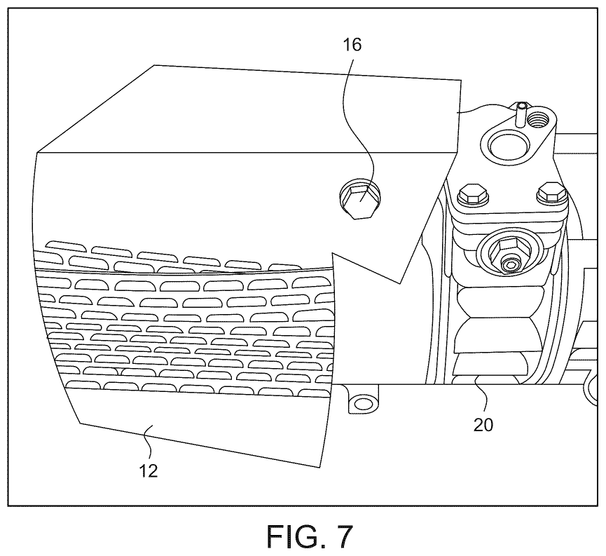

The electric fan A/C kit 100 may include a generally compact and cylindrical or oval-shaped, similar in size or slightly smaller than a traditional mechanical compressor. There is a housing 12 made of durable metal (usually aluminum or cast aluminum) to withstand pressure and heat. The housing 12 encloses the electric motor 10 and at least a portion of the compression mechanism 20, and in some embodiments the housing is fixed to both, as illustrated in FIGS. 6 and 7.

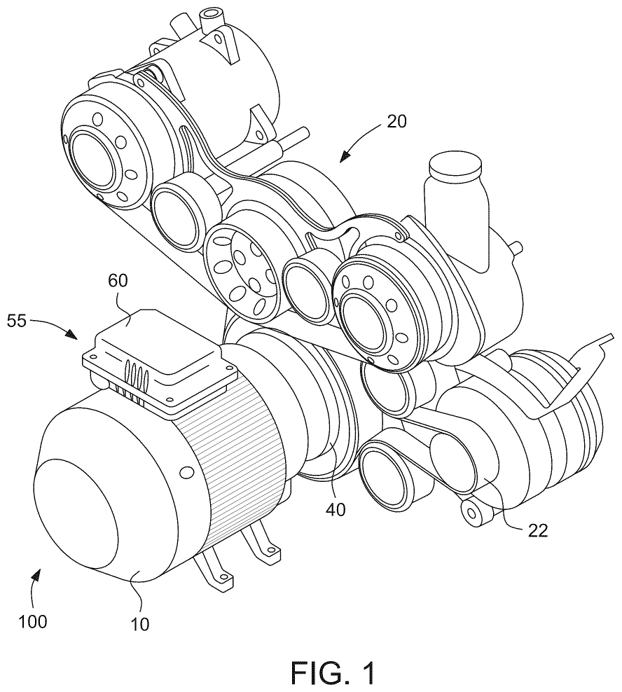

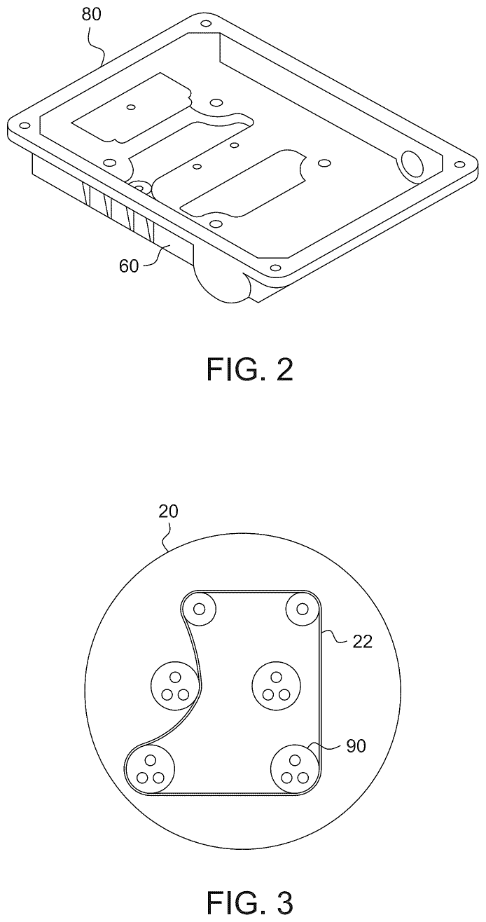

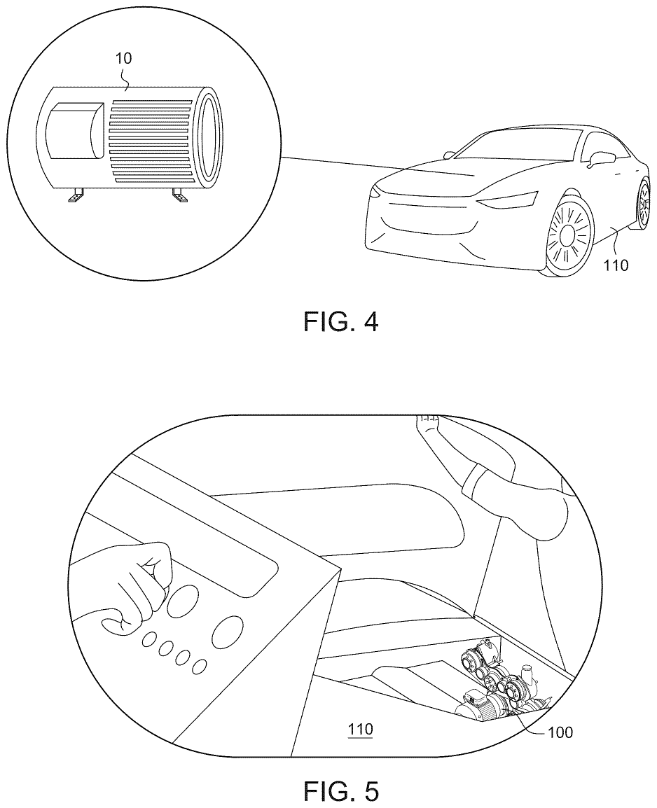

The intrinsic compressor unit 20 of the vehicle 110 has refrigerant ports for suction and discharge lines (usually metal fittings with threaded or quick-connect ends). The electric fan A/C kit 100 operatively associates the electric motor 10 with the intrinsic compressor unit 20 to selectively operate their compressors 30. Specifically, the intrinsic pulley system 40 may be electrically powered and selectively controlled by the newly added electric motor 10, whereby the intrinsic pulley system 40 continues to engage the intrinsic belt mechanism 22 as shown in FIGS. 1 and 3.

The electric fan A/C kit 100 may include a wiring plug or connector for power and control signals, typically located on the compressor body. The electric fan A/C kit 100 may also include multiple bolt holes or brackets to securely mount it to the vehicle chassis 110 or HVAC system frame.

Within the housing, a built-in electric motor 10 drives the compressor(s) 90, housed in the intrinsic compressor unit 20 by way of an intrinsic belt mechanism 22. In the prior art, the intrinsic belt mechanism 22 is mechanically engaged (say, via a pulley operatively associated with the engine of the vehicle 110); here, in the subject disclosure, the electric motor 10 selectively engages the intrinsic belt mechanism 22 by way of the control unit 55. Typically, the subject disclosure is lighter than mechanical compressors because of the lack of relatively heavy pulley or clutch assemblies. Moreover, unlike mechanical compressors, there is no external pulley or belt attachment; power is supplied electrically directly to the compressor(s) 90.

The intrinsic compressor unit 20 is a compact, metal-cased unit with refrigerant ports and an electrical connector, housing an electric motor and compression mechanism designed for efficient refrigerant circulation without mechanical linkage to the engine. The electric A/C compressor 30 within the intrinsic compressor unit 20 compresses and circulates refrigerant in a vehicle's air conditioning system using electrical power instead of mechanical power from the engine.

More specifically, the electric A/C compressor 30 compresses low-pressure refrigerant vapor into high-pressure, high-temperature vapor, enabling the refrigerant to release heat in the condenser. The subject disclosure circulates the refrigerant through the A/C system to maintain the refrigeration cycle and provide cooling to the vehicle cabin. The subject disclosure operates independently of engine speed because it is powered by an electric motor and controlled electronically, thereby enabling precise control of compressor speed and output to match cooling demand efficiently, improving energy use and cabin comfort.

In short, the electronic A/C compressor's function is to provide reliable, efficient, and controllable air conditioning by compressing and pumping refrigerant electrically, thereby enabling better performance across all driving conditions. And so, when the vehicle's air conditioning system uses electrical power instead of mechanical power from the engine there is reduced emissions and noise. Less engine load means reduced CO2 emissions, less noise and vibration, thereby contributing to a quieter cabin. Electric fan A/C kit compressors 30 use electronic control systems to adjust compressor speed based on cooling demand, improving overall system efficiency and passenger comfort.

As used in this application, the term “about” or “approximately” refers to a range of values within plus or minus 10% of the specified number. And the term “substantially” refers to up to 80% or more of an entirety. Recitation of ranges of values herein is not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A method of improving an air-conditioning system intrinsic to a vehicle having a mechanical engagement linkage between the intrinsic air-conditioning system and an intrinsic internal combustion engine of the vehicle, the method comprising:
permanently removing said mechanical engagement linkage; and
operatively associating an electric motor to the air-conditioning system so that an intrinsic belt mechanism of the intrinsic air-conditioning system is driven by the electric motor.

2. The method of claim 1, wherein the air-conditioning system comprises an intrinsic vehicular compressor unit housing the intrinsic belt mechanism and operatively associated one or more compressors.

3. The method of claim 1, wherein the mechanical engagement linkage is an external pulley or belt attachment operatively associated with said intrinsic internal combustion engine, and wherein the electric motor has a pulley element to driving the intrinsic belt mechanism of the intrinsic air-conditioning system.

4. The method of claim 2, further comprising fixing a housing to the electric motor and the intrinsic vehicular compressor unit with fasteners.

5. A kit for improving an air-conditioning system intrinsic to a vehicle having a mechanical engagement linkage between the intrinsic air-conditioning system and the engine of the vehicle, the kit comprising:
an electric motor dimensioned and shaped to operatively associate with the intrinsic air-conditioning system; and
a housing dimensioned and shaped to be connected to both the electric motor and an intrinsic vehicular compressor unit of the air-conditioning system.
